(19) United States
(12) Patent Application Publication
(10) Pub. No.: US 2025/0259221 A1
(43) Pub. Date: Aug. 14, 2025

(54) MACHINE LEARNING MODEL FOR PREDICTING TRAVEL FOR RECOMMENDING CONTENT TO A USER OF AN ONLINE SYSTEM

(71) Applicant: Maplebear Inc., San Francisco, CA (US)

(72) Inventors: Madeline Mesard, New York, NY (US); Shaun Navin Maharaj, Vaughan (CA); Brent Scheibelhut, Toronto (CA)

(21) Appl. No.: 18/441,843

(22) Filed: Feb. 14, 2024

(51) Int. Cl. G06Q 30/0601

(52) U.S. Cl. CPC G06Q 30/0631; G06Q 30/0633

(57) ABSTRACT

A trained computer model is used to generate content for recommendation to a user of an online system based on prediction of a future travel of the user. The online system accesses a computer model trained to output a likelihood of the user conducting a travel within a future time period. The computer model outputs, based on user data associated with the user, the likelihood of the user conducting the travel within the future time period. Responsive to the likelihood of the user conducting the travel being above a threshold value, the online system generates, based on information about conversion by the user of a set of items during a past time period, a list of items for recommendation to the user. The online system causes a device associated with the user to display a user interface with the list of items for inclusion into a cart of the user.

### BACKGROUND

Present-day online systems, such as online concierge systems, utilize machine-learning computer models to provide various recommendations to their users. The traditional machine-learning models are typically trained to provide recommendations based on purchasing affinities of individual users or specific groups of users. If predicting a future travel of an individual user was possible, an online system would be able to provide improved recommendations to that particular user that are tailored to the user's current travel-related needs. For example, it would be beneficial for a user of an online system to be reminded by the online system to stock groceries at the start of a vacation in order to avoid having to go to a grocery store during the vacation, or to be reminded by the online system to restock groceries at home that can be promptly ingested when the user returns from a trip. However, the traditional machine-learning models are not trained to anticipate future travels of individual users of online systems and to provide personalized recommendations to those users who are traveling in the near future based on their anticipated travels. This limits the ability of a user interface at an online system to present useful content to a user who is traveling in the near future.

Hence, there is a technical problem of predicting a future travel of a user of an online system that the traditional machine-learning models cannot solve. Therefore, there is a need for a new type of machine-learning model approach when providing travel-specific recommendations to a user of an online system who is traveling in the near future.

### SUMMARY

Embodiments of the present disclosure are directed to utilizing a trained computer model to generate content for recommendation to a user of an online system (e.g., online concierge system) based on prediction of a future travel of the user.

In accordance with one or more aspects of the disclosure, responsive to a user of an online system engaging with the online system, the online system accesses a travel prediction computer model of the online system, wherein the travel prediction computer model is trained to output a likelihood of the user conducting a travel within a future time period. The online system applies the travel prediction computer model to output, based at least in part on user data associated with the user, the likelihood of the user conducting the travel within the future time period. Responsive to the likelihood of the user conducting the travel being above a threshold value, the online system generates, based at least in part on information about conversion by the user of a set of items during a past time period, a list of one or more items for recommendation to the user. The online system causes a device associated with the user to display a user interface with the list of one or more items for inclusion into a cart of the user.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example user interface of a user client device with content recommended to a user of an online concierge system based on prediction of a future travel of the user, in accordance with one or more embodiments.

FIG. 4 is a flowchart for a method of using a trained computer model to generate content for recommendation to a user of an online concierge system based on prediction of a future travel of the user, in accordance with one or more embodiments.

### DETAILED DESCRIPTION

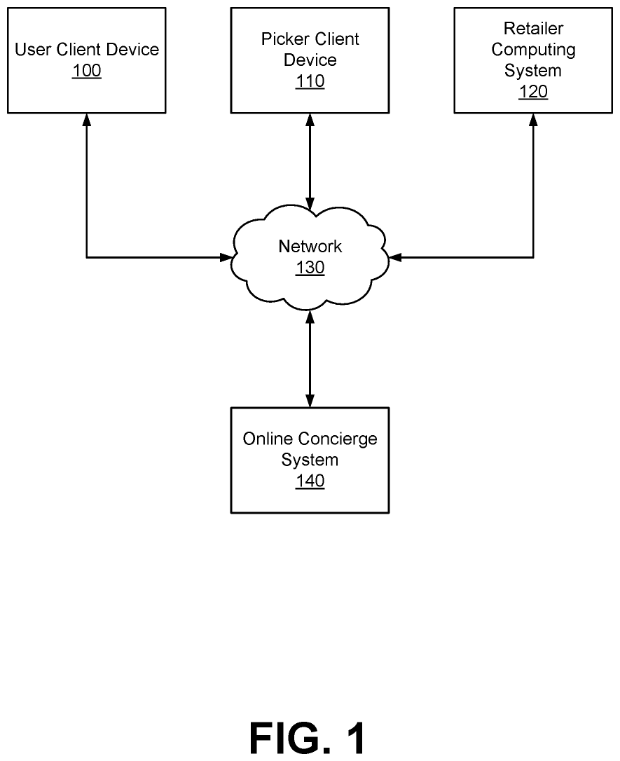

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 may utilize trained computer models (e.g., machine-learning computer models) to predict a user's future travel (including a type of the travel) and recommend items to the user based on the prediction. The online concierge system 140 may predict the future travel using a travel prediction computer model that is trained to predict whether a user will travel within a future time window based on a set of input features. The travel prediction computer model may be initially trained to predict future travels based on data related to recent purchases of the user and/or other users of the online concierge system 140 that are related to recent travels. The input features provided to the travel prediction computer model for predicting the user's future travel may include information such as purchase and/or engagement history with items on the online concierge system 140, integration data with one or more payment card entities, setting a temporary delivery address using the online concierge system 140, a shared location via a device associated with the user (e.g., the user client device 100), integration with one or more third-party systems using widgets, or some other travel-related information.

Once the travel prediction computer model predicts that the user will be traveling in a future time window, the online concierge system 140 may use another trained computer model (e.g., multiclass classifier) to predict a type of the user's travel (e.g., beach vacation, family trip, business trip, etc.). The multiclass classifier may be trained to predict the type of travel by utilizing, e.g., data with information that maps different purchases to different travel types. Once the multiclass classifier predicts the type of travel, the online concierge system 140 may then recommend specific items for the predicted type of travel. The online concierge system 140 may keep track of past purchases that a group of users conducted in similar travel settings (i.e., same or similar types of travel as the predicted type of travel) and suggest same or similar items that were previously purchased by the group of users. For example, if the group of users purchased a bug spray when vacationing in Arizona, the online concierge system 140 may suggest the same bug spray to a user of the online concierge system 140 who is predicted to be traveling soon to Arizona.

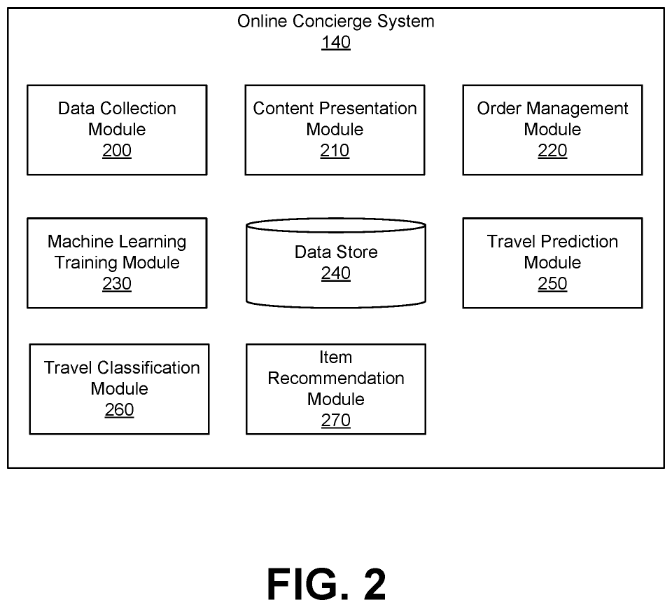

In this manner, the online concierge system 140 may outreach to users who are traveling with a specific call-to-action based on their type of travel, in order to motivate them to incorporate orders at the online concierge system 140 into their travel plans. For example, when a user is in a transit home, the online concierge system 140 can send a push notification to the user to restock their kitchen and schedule a delivery to arrive after they get home. Additionally, when a user is staying in a rental home, the online concierge system 140 may send a message to the user such as “don't waste time shopping on vacation” and recommend content that could be delivered at the time of their arrival at the rental home. As part of an integration to the online concierge system 140, the user may have the opportunity to voluntarily allow sharing user-related information from, e.g., their credit card provider and/or third-party travel site so that information about their upcoming trip can be shared with the online concierge system 140. The online concierge system 140 would then provide shopping recommendations to the user based on the shared information about their upcoming trip, as well as to suggest where the order should be delivered to. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a travel prediction module 250, a travel classification module 260, and an item recommendation module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The travel prediction module 250 may predict a likelihood (i.e., probability) that a user of the online concierge system 140 will travel during a future time window. The travel prediction module 250 may access a travel prediction computer model (e.g., machine-learning computer model) that is trained to compute a likelihood of the user conducting a travel (i.e., moving from a home location to one or more geographical locations different from the home location) within the future time period. The travel prediction module 250 may deploy the travel prediction computer model to run a machine-learning algorithm to compute, based at least in part on user data associated with the user, the likelihood of the user conducting the future travel. The travel prediction module 250 may be also trained to predict a user's travel for a pre-defined time period in advance (e.g., two days in advance, one week in advance, etc.). A set of parameters for the travel prediction computer model may be stored at one or more non-transitory computer-readable media of the travel prediction module 250. Alternatively, the set of parameters for the travel prediction computer model may be stored at one or more non-transitory computer-readable media of the data store 240.

The travel prediction module 250 may generate one or more inputs for the travel prediction computer model. The one or more inputs may represent the user data including information about user's recent purchases at the online concierge system 140 that could be related to a future travel (e.g., placing orders for adaptors, neck pillows, eye masks, etc.), information about user's purchases at third-party sites that could be related to a future travel (e.g., user's hotel reservation or user's rental home reservation at a third-party travel site), information about the user setting a secondary address at the online concierge system 140 (e.g., vacation home address), information about a user's geographical location that could be related to a future travel (e.g., as shared with the online concierge system 140 via the user client device 100), information about user's integration with a third-party travel site (e.g., putting a widget on the third-party travel site to “stock groceries for trip”), and/or some potential travel-related information. It should be noted that information about the user's past purchases at third-party sites as well as information about the user's integration with third-party travel sites can be obtained only after the user voluntarily agreed to share data from the third-party sites with the online concierge system 140.

Responsive to the predicted likelihood of the user conducting the travel (e.g., as computed by the travel prediction computer model) being above a pre-determined threshold value, the travel prediction module 250 (or some other module of the online concierge system 140) may generate a list of items for recommendation to the user. Hence, once the travel prediction computer model predicts the user's future travel, the travel prediction module 250 may recommend appropriate content for conversion by the user, such as, suitable purchasing items, promotion opportunities at third-party travel sites, referral codes for third-party travel sites, fulfillment to hotels and/or rental homes, etc. Furthermore, the travel prediction computer model may predict user's dietary changes based on changes from past purchases associated with past travels and suggest suitable alternatives (e.g., keto-friendly bread). Additionally, the travel prediction computer model may predict that certain items which a user frequently purchases are not allowed while traveling, and suggest travel-size versions of these items for inclusion into a shopping cart (e.g., travel-size toothpaste, travel-size deodorant, travel-size shampoo, travel-size bug spray, etc.) Also, once the travel prediction computer model predicts the user's future travel, the travel prediction module 250 may recommend cold medications and other similar items so that the user could be better prepared for an eventual sickness during the travel.

The travel classification module 260 may classify a predicted user's future travel (e.g., as predicted by the travel prediction computer model) into multiple travel type classifications (e.g., business, beach, family, romantic, etc.). The type of the user's future travel as predicted by the travel classification module 260 may include information about one or more geographical locations of the future travel. The type of travel may also be predicted based on a geographical location of the travel and a time period of the travel. For example, traveling to Colorado in the winter can mean that the type of future travel is a ski trip, while traveling to Nashville in the spring can mean that the type of trip is bachelor party.

The travel classification module 260 may access a travel classification computer model (e.g., multiclass heuristic-based machine-learning computer model) of the online concierge system 140 that is trained to predict a type of the user's future travel. The travel classification module 260 may deploy the travel classification computer model to run a machine-learning algorithm to predict, based at least in part on the user data, the type of user's future travel. In one or more embodiments, the travel classification computer model may determine, based at least in part the user data, one or more geographical locations associated with the user's future travel as part of the predicted type of travel. Furthermore, the travel classification computer model may generate, based at least in part on the user data and the predicted type of user's future travel (e.g., including information about the one or more geographical locations associated with the user's future travel), a list of items for recommendation to the user. In general, an output of the travel classification computer model may be an identification (ID) of the user and a predicted travel type. A set of parameters for the travel classification computer model may be stored at one or more non-transitory computer-readable media of the travel classification module 260. Alternatively, the set of parameters for the travel classification computer model may be stored at one or more non-transitory computer-readable media of the data store 240.

In one or more embodiments, the travel classification computer model generates the list of items for recommendation to the user based on the predicted type of travel. For example, an order to stock up a rental home for a bachelorette party trip is different from an order to buy office snacks and quick breakfasts for business travel. In one or more other embodiments, the travel classification computer model may generate the list of items for recommendation to the user based on the user's purchase history at the geographical location of the predicted user's future travel (or at a defined vicinity of the geographical location). In one or more other embodiments, the travel classification computer model may generate the list of one or more items for recommendation to the user based on popularity information, i.e., based on what other users of the online concierge system 140 purchased at the same geographical location of the predicted user's future travel (or at a defined vicinity of the geographical location).

The travel classification computer model may personalize the recommended content based on the predicted travel type and the user data (e.g., user's purchase history) in order to identify the most relevant type of travel items for recommendation to a specific user. For example, the travel classification computer model may provide location-based recommendations such as local items and geographically relevant items (e.g., sunscreen on a beach vacation), as well as items with personal relevance (e.g., easy meals for families in a rental home, and snacks and alcoholic beverages for predicted friend group trips, etc.). The online concierge system 140 may be prepopulated (e.g., at the data store 240) with pre-educated suggestions based on various locations that are collected based on past purchases within close regions of the predicted user's future travel. This may enable the travel classification computer model to provide item recommendations isolated to specific regions. The travel classification computer model may obtain travel information from a user, and perform a lookup of the data store 240 based on the travel information, along with intersecting for any other data which the user provides as intake (e.g., dietary restrictions, past purchase interests, etc.) This will ensure the online concierge system 140 provides recommendations that are not solely based on the travel location, but also incrementally include personalized items for the specific user.

The item recommendation module 270 may identify, based on information about a predicted user's future travel and user data, a list of items for recommendation to a user of the online concierge system 140. Upon predicting that the user is traveling in a future time window at a specific travel destination, the item recommendation module 270 may suggest the list of items for a user's shopping cart. The item recommendation module 270 may access an item recommendation computer model (e.g., machine-learning ranking model) of the online concierge system 140 that is trained to generate a score for each item of a catalog of items (e.g., as available at the data store 240). The item recommendation module 270 may deploy the item recommendation computer model to run a machine-learning algorithm to generate, based on input data related to the predicted user's travel (including the predicted travel destination), the score for each item in the catalog of items. The recommendation module 270 (or the item recommendation computer model) may then identify, based on the score for each item, the list of items for recommendation to the user. A set of parameters for the item recommendation computer model may be stored at one or more non-transitory computer-readable media of the item recommendation module 270. Alternatively, the set of parameters for the item recommendation computer model may be stored at one or more non-transitory computer-readable media of the data store 240.

The item recommendation module 270 may generate the input data for the item recommendation computer model. For example, in generating the input data, the item recommendation module 270 may generate at least one of: (1) information about the travel destination including a type of the travel, (2) information about one or more events occurring at the travel destination during a time window of the future travel, (3) information about cultural norms at the travel destination, (4) user's data related to cultural and/or culinary exploration, (5) information about health factors in a region of the travel destination, (6) a season when the future travel occurs, (7) a time duration (e.g., number of days, number of weeks, etc.) of the travel, (8) information about user's accommodations during the travel, (9) a shopping history of the user related to past travels (e.g., as available at the data store 240), or (10) a shopping history of one or more other users of the online concierge system 140 related to past travels (e.g., as available at the data store 240). Based on the input data, the item recommendation computer model may generate an output that includes the list of items that are relevant to the user as well as to the type of travel the user is taking.

The various input data listed above may provide different useful information for the item recommendation computer model. For example, information about the travel destination and the type of travel when input into the item recommendation computer model may allow the online concierge system 140 to surface trending products in an area of the travel destination, seasonally relevant items, and/or items purchased for other trips to that specific location. Information about the events occurring at the travel destination when input into the item recommendation computer model may provide information that the user travels to the travel destination for a specific event (e.g., Burning Man, Indy 500, etc.). The item recommendation computer model may utilize the information about the specific event to suggest items that are suitable for this particular event (e.g., tents for Burning Man, packs of beer for Indy 500, etc.). Information about the cultural norms when input into the item recommendation computer model may allow the item recommendation computer model to be aware of different cultural norms and customs related to food at the travel destination, including dining etiquette, dietary restrictions, etc. Furthermore, information about the user's cultural and culinary exploration (e.g., including user's interest in experiencing local cuisines) when input into the item recommendation computer model may prompt the item recommendation computer model to recommend one or more items that include authentic dishes from the travel destination.

As aforementioned, the item recommendation computer model may consider various health factors (or, more generally, health implications) in the region of the travel destination for generating recommended content for the user. For example, for predicted travels to hotter areas, the item recommendation computer model may favor items that are suitable for a warmer climate (e.g., ice cream), while omitting items that are on, e.g., “recall watch lists.” Information about the duration of the predicted travel when input into the item recommendation computer model may be beneficial so that the item recommendation computer model may recommend smaller size items for shorter trips. Information about the user's accommodation during the travel (e.g., information about access to a kitchen) when input into the item recommendation computer model may be beneficial so that the item recommendation computer model may recommend items for cooking vs. premade items, snacks, drinks, etc. Information about the user's prior shopping history when input into the item recommendation computer model may allow the item recommendation computer model to personalize recommendations based on user's shopping preferences. For example, after predicting what type of vacation the user will have (e.g., as predicted by the travel classification computer model) and based on the user's shopping preferences, the item recommendation computer model may recommend specific groceries for a family vacation, or sunscreen and bug spray for a camping trip.

The content presentation module 210 may obtain (e.g., from the travel prediction module 250, the travel classification module 260, and/or the item recommendation module 270) a list of items for recommendation to the user in relation to the user's future travel. The content presentation module 210 may cause the user client device 100 to display (e.g., before the checkout or at the checkout) a user interface with the list of recommended items. The user may be then allowed to add any of the recommended items to a shopping cart. The content presentation module 210 may also send specific notifications (e.g., electronic mails, SMS, etc.) to the user in order to alert the user of travel-specific recommendations. As the travel classification computer module may predict a type of travel that the user will conduct in a near future, the content presentation module 210 may generate and surface one or more messages for the user that are specialized for the predicted type of travel.

The machine-learning training module 230 may perform initial training and re-training of the travel prediction computer model, based on data (e.g., as available at the data store 240) collecting part purchases of the user and/or one or more other users of the online concierge system 140 that are related to past travels. Furthermore, information about integration with a third-party system using a travel-related widget (e.g., placing a widget on a third-party travel site to “stock groceries for trip”) is a very strong indication of a future travel and may be utilized by the machine-learning training module 230 as a ground truth label for initial training and/or re-training of the travel prediction computer model. In one or more embodiments, the machine-learning training module 230 performs initial training of the travel classification computer model to predict a type of future travel based on collected data with mappings between purchased items and types of travel where each subset of purchased items is mapped to a specific class (i.e., type) of travel. In one or more other embodiments, the machine-learning training module 230 performs initial training of the item recommendation computer model based on collected data that maps users' favorite purchased items to specific types of travel and/or specific travel destinations.

The machine-learning training module 230 may collect information about the user's response to the list of recommended items (engagement information such as viewing information and/or conversion information) displayed at the user interface of the user client device 100. The machine-learning training module 230 may then use the collected information for updating the set of parameters of the travel prediction computer model, the set of parameters of the travel classification computer model, and/or the set of parameters of the item recommendation computer model. Furthermore, the content presentation module 210 may cause the user client device 100 to display the user interface further with one or more messages prompting the user to confirm or deny whether a predicted travel will indeed occur and/or whether a particular predicted type of travel will occur. The user's response to this type of messages may be used by the machine-learning computer model 230 to re-train the travel prediction computer model and/or the travel classification computer model. By utilizing engagement and conversion information as well as users' explicit feedback about predicted travels, the machine-learning computer model 230 can continuously update and improve the travel prediction computer model, the travel classification computer model, and/or the item recommendation computer model.

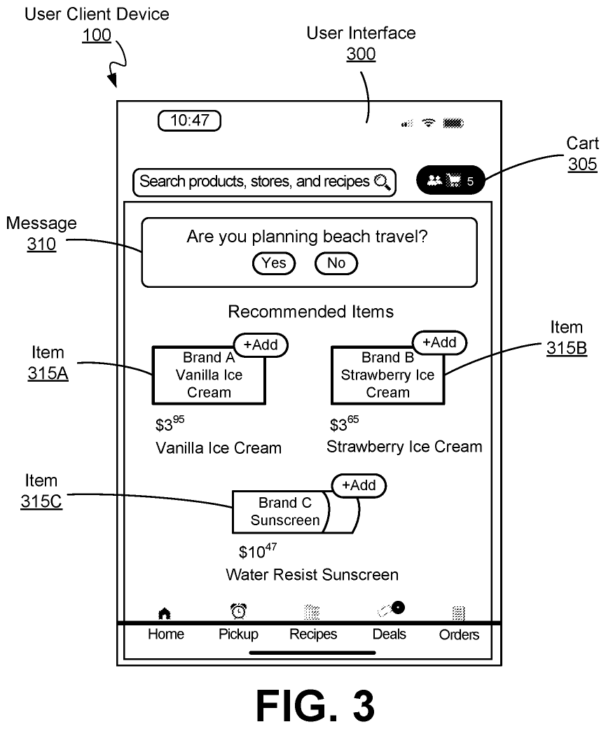

FIG. 3 illustrates an example user interface 300 of a user client device 100 with content recommended to a user of the online concierge system 140 based on prediction of a future travel of the user, in accordance with one or more embodiments. The user interface 300 may be displayed during an ordering session of the user (e.g., before the checkout or at the checkout) before or after the user has already included a certain number of items into a cart 305. The content presentation module 210 may cause the user client device 100 to display the user interface 300 with a message 310 (e.g., “Are you planning beach travel?”) prompting the user to provide feedback whether the predicted type of travel will indeed occur. The user's response to the message 310 may be used (e.g., by the machine-learning training module 230) for re-training of the travel prediction computer model and/or the travel classification computer model. The content presentation module 210 may further cause the user interface 300 to display an item 315A (e.g., “Vanilla Ice Cream”), an item 315B (e.g., “Strawberry Ice Cream”) and an item 315C (e.g., “Water Resist Sunscreen”) for recommendation to the user based on the predicted type of travel (e.g., beach travel). For example, the items 315A, 315B, 315C may be identified by the item recommendation computer model as items with highest ranking scores for the predicted type of travel while being personalized for the specific user. The user may utilize the user interface 300 to add any of the recommended items 315A, 315B, 315C into the cart 305. Data about the user's conversion of any of the items 315A, 315B, 315C (or other types of user's engagement with the 315A, 315B, 315C) may be utilized (e.g., by the machine-learning training module 230) for re-training of the item recommendation computer model. Although FIG. 3 shows three recommended items, it should be understood that the user interface 300 may display less than three recommended items or more than three recommended items. It should be also noted that the content presentation module 210 may cause the user client device 100 to display the user interface 300 only with the items 315A, 315B, 315C without displaying the message 310.

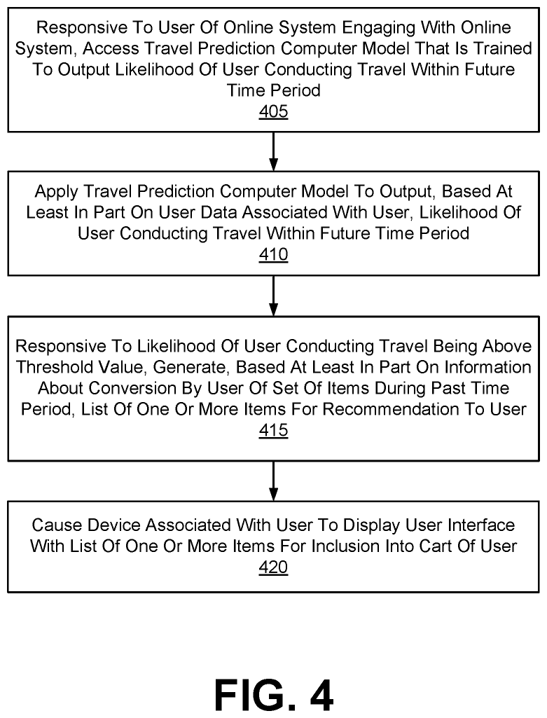

FIG. 4 is a flowchart for a method of using a trained computer model to generate content for recommendation to a user of an online concierge system based on prediction of a future travel of the user, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

Responsive to a user of the online concierge system 140 engaging with the online concierge system 140 (e.g., placing an order with the online concierge system 140, browsing the online concierge system 140, etc.), the online concierge system 140 accesses 405 a travel prediction computer model of the online concierge system 140 (e.g., via the travel prediction module 250), wherein the travel prediction computer model is trained to output a likelihood of the user of conducting a travel within a future time period. The online concierge system 140 applies 410 the travel prediction computer model (e.g., via the travel prediction module 250) to output, based at least in part on user data associated with the user, the likelihood of the user conducting the travel within the future time period.

The online concierge system 140 may generate (e.g., via the travel prediction module 250) the user data for input into the travel prediction computer model. The user data input into the travel prediction computer model may include at least one of: the information about conversion by the user of the set of items during the one or more past time periods, information about integration of the user with one or more payment card entities, data associated with the user setting a temporary delivery address using the online concierge system 140, one or more geographical locations of the user shared via the device, or information about integration of the user with one or more online systems using one or more widgets.

The online concierge system 140 may access a travel classification computer model of the online concierge system 140 (e.g., via the travel classification module 260), wherein the travel classification computer model is trained to predict a type of the travel. The online concierge system 140 may apply the travel classification computer model (e.g., via the travel classification module 260) to predict, based at least in part on the user data, the type of travel. In one or more embodiments, the online concierge system 140 may apply the travel classification computer model (e.g., via the travel classification module 260) to identify, based at least in part the user data, one or more geographical locations (e.g., one or more travel destinations) associated with the travel as part of the predicted type of travel.

Responsive to the likelihood of the user conducting the travel being above a threshold value, the online concierge system 140 generates 415 (e.g., via the travel prediction module 250, the travel classification module 260, and/or the item recommendation module 270), based at least in part on information about conversion by the user of a set of items during a past time period, a list of one or more items for recommendation to the user. The online concierge system 140 causes 420 (e.g., via the content presentation module 210) a device associated with the user (e.g., the user client device 100) to display a user interface with the list of one or more items for inclusion into a cart of the user.

In one or more embodiments, the online concierge system 140 applies the travel classification computer model (e.g., via the travel classification module 260) to identify, based at least in part on the user data and the predicted type of travel, the list of one or more items for recommendation to the user. In one or more other embodiments, the online concierge system 140 applies the travel classification computer model (e.g., via the travel classification module 260) to identify, based at least in part on information about one or more items that the user converted during one or more past time periods when the user was located within a threshold vicinity from the previously determined one or more geographical locations associated with the travel, the list of one or more items for recommendation to the user. In one or more other embodiments, the online concierge system 140 applies the travel classification computer model (e.g., via the travel classification module 260) to identify, based at least in part on information about one or more items that one or more other users of the online concierge system 140 converted during one or more past time periods when the one or more users were located within a threshold vicinity from the previously determined one or more geographical locations associated with the travel, the list of one or more items for recommendation to the user.

In one or more other embodiments, the online concierge system 140 accesses an item recommendation ranking model of the online concierge system 140 (e.g., via the item recommendation module 270), wherein the item recommendation ranking model is trained to generate a score for each item of a plurality of items. The online concierge system 140 may apply the item recommendation ranking model (e.g., via the item recommendation module 270) to generate, based on at least one of first data associated with the one or more geographical locations, second data with further information about the travel, or third data including a portion of the user data, the score for each item of the plurality of items. Finally, the online concierge system 140 may apply the item recommendation ranking model (e.g., via the item recommendation module 270) to identify, based on the score for each item of the plurality of items, the list of one or more items for recommendation to the user.

The online concierge system 140 may generate (e.g., via the item recommendation module 270) at least one of the first data, the second data, or the third data for input into the item recommendation ranking model. In generating the first data, the online concierge system 140 may generate (e.g., via the item recommendation module 270) at least one of: information about past conversions associated with the one or more geographical locations, information about a season during which the user travels to the one or more geographical locations, information about one or more events occurring during the future time period at the one or more geographical locations, information about one or more cultural norms associated with the one or more geographical locations, culinary information for the one or more geographical locations, or health information for the one or more geographical locations. In generating the second data, the online concierge system 140 may generate (e.g., via the item recommendation module 270) at least one of: information about the future time period of the travel, information about a length of the travel, or information about one or more accommodations associated with the user during the travel. In generating the third data, the online concierge system 140 may generate (e.g., via the item recommendation module 270) information about conversion by the user of one or more items during one or more past time periods.

The online concierge system 140 may collect (e.g., via the machine-learning training module 230) feedback data with information about a conversion by the user of each item from the list of one or more items. The online concierge system 140 may re-train the travel prediction computer model by updating (e.g., via the machine-learning training module 230), based at least in part on the collected feedback data, a set of parameters of the travel prediction computer model.

The online concierge system 140 may cause (e.g., via the content presentation module 210) the device associated with the user to display the user interface further with a message prompting the user to provide feedback in relation to the predicted type of travel. The online concierge system 140 may collect (e.g., via the machine-learning training module 230) the feedback provided by the user. The online concierge system 140 may re-train the travel classification computer model by updating (e.g., via the machine-learning training module 230), based at least in part on the collected feedback, a set of parameters of the travel classification computer model.

Embodiments of the present disclosure are directed to the online concierge system 140 that utilizes a trained computer model to predict a user's future travel based on activity of the user in relation to the online concierge system 140 and/or purchase integrations (e.g., with one or more other online systems). The online concierge system 140 can further utilize another trained computer model to predict a type of the user's travel, and then recommend items for purchase based on the predicted type of travel.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
responsive to a user of an online system engaging with the online system, accessing a travel prediction computer model of the online system, wherein the travel prediction computer model is trained to output a likelihood of the user conducting a travel within a future time period;
applying the travel prediction computer model to output, based at least in part on user data associated with the user, the likelihood of the user conducting the travel within the future time period;
responsive to the likelihood of the user conducting the travel being above a threshold value, generating, based at least in part on information about conversion by the user of a set of items during a past time period, a list of one or more items for recommendation to the user; and
causing a device associated with the user to display a user interface with the list of one or more items for inclusion into a cart of the user.

2. The method of claim 1, further comprising:
generating the user data for input into the travel prediction computer model, the user data comprising at least one of the information about conversion by the user of the set of items during the one or more past time periods, information about integration of the user with one or more payment card entities, data associated with the user setting a temporary delivery address using the online system, one or more geographical locations of the user shared via the device, or information about integration of the user with one or more online systems using one or more widgets.

3. The method of claim 1, further comprising:
collecting feedback data with information about a conversion by the user of each item from the list of one or more items; and
re-training the travel prediction computer model by updating, based at least in part on the collected feedback data, a set of parameters of the travel prediction computer model.

4. The method of claim 1, further comprising:
accessing a travel classification computer model of the online system, wherein the travel classification computer model is trained to predict a type of the travel; and
applying the travel classification computer model to predict, based at least in part on the user data, the type of travel.

5. The method of claim 4, wherein displaying the user interface further comprising:
causing the device associated with the user to display the user interface further with a message prompting the user to provide feedback in relation to the predicted type of travel;
collecting the feedback provided by the user; and
re-training the travel classification computer model by updating, based at least in part on the collected feedback, a set of parameters of the travel classification computer model.

6. The method of claim 4, wherein generating the list of one or more items comprises:
applying the travel classification computer model to identify, based at least in part on the user data and the predicted type of travel, the list of one or more items for recommendation to the user.

7. The method of claim 4, wherein applying the travel classification computer model comprises:
applying the travel classification computer model to identify, based at least in part the user data, one or more geographical locations associated with the travel as part of the predicted type of travel.

8. The method of claim 7, wherein generating the list of one or more items comprises:
applying the travel classification computer model to identify, based at least in part on information about one or more items that the user converted during one or more past time periods when the user was located within a threshold vicinity from the one or more geographical locations, the list of one or more items for recommendation to the user.

9. The method of claim 7, wherein generating the list of one or more items comprises:
applying the travel classification computer model to identify, based at least in part on information about one or more items that one or more other users of the online system converted during one or more past time periods when the one or more users were located within a threshold vicinity from the one or more geographical locations, the list of one or more items for recommendation to the user.

10. The method of claim 7, wherein generating the list of one or more items comprises:
accessing an item recommendation ranking model of the online system, wherein the item recommendation ranking model is trained to generate a score for each item of a plurality of items;
applying the item recommendation ranking model to generate, based on at least one of first data associated with the one or more geographical locations, second data with further information about the travel, or third data including a portion of the user data, the score for each item of the plurality of items; and
applying the item recommendation ranking model to identify, based on the score for each item of the plurality of items, the list of one or more items for recommendation to the user.

11. The method of claim 10, further comprising at least one of:
generating the first data for input into the item recommendation ranking model, the first data comprising at least one of information about past conversions associated with the one or more geographical locations, information about a season during which the user travels to the one or more geographical locations, information about one or more events occurring during the future time period at the one or more geographical locations, information about one or more cultural norms associated with the one or more geographical locations, culinary information for the one or more geographical locations, or health information for the one or more geographical locations;
generating the second data for input into the item recommendation ranking model, the second data comprising at least one of information about the future time period of the travel, information about a length of the travel, or information about one or more accommodations associated with the user during the travel; or
generating the third data for input into the item recommendation ranking model, the third data comprising information about conversion by the user of one or more items during one or more past time periods.

12. A computer program product comprising a non-transitory computer readable storage medium having instructions encoded thereon that, when executed by a processor, cause the processor to perform steps comprising:
responsive to a user of an online system engaging with the online system, accessing a travel prediction computer model of the online system, wherein the travel prediction computer model is trained to output a likelihood of the user conducting a travel within a future time period;
applying the travel prediction computer model to output, based at least in part on user data associated with the user, the likelihood of the user conducting the travel within the future time period;
responsive to the likelihood of the user conducting the travel being above a threshold value, generating, based at least in part on information about conversion by the user of a set of items during a past time period, a list of one or more items for recommendation to the user; and
causing a device associated with the user to display a user interface with the list of one or more items for inclusion into a cart of the user.

13. The computer program product of claim 12, wherein the instructions further cause the processor to perform steps comprising:
generating the user data for input into the travel prediction computer model, the user data comprising at least one of the information about conversion by the user of the set of items during the one or more past time periods, information about integration of the user with one or more payment card entities, data associated with the user setting a temporary delivery address using the online system, one or more geographical locations of the user shared via the device, or information about integration of the user with one or more online systems using one or more widgets.

14. The computer program product of claim 12, wherein the instructions further cause the processor to perform steps comprising:
collecting feedback data with information about a conversion by the user of each item from the list of one or more items; and
re-training the travel prediction computer model by updating, based at least in part on the collected feedback data, a set of parameters of the travel prediction computer model.

15. The computer program product of claim 12, wherein the instructions further cause the processor to perform steps comprising:
accessing a travel classification computer model of the online system, wherein the travel classification computer model is trained to predict a type of the travel; and
applying the travel classification computer model to predict, based at least in part on the user data, the type of travel.

16. The computer program product of claim 15, wherein the instructions further cause the processor to perform steps comprising:
applying the travel classification computer model to identify, based at least in part on the user data and the predicted type of travel, the list of one or more items for recommendation to the user.

17. The computer program product of claim 15, wherein the instructions further cause the processor to perform steps comprising:
applying the travel classification computer model to identify, based at least in part the user data, one or more geographical locations associated with the travel as part of the predicted type of travel.

18. The computer program product of claim 17, wherein the instructions further cause the processor to perform steps comprising:
applying the travel classification computer model to identify, based at least in part on information about a set of items that the user converted during one or more past time periods when the user was located within a threshold vicinity from the one or more geographical locations, the list of one or more items for recommendation to the user.

19. The computer program product of claim 17, wherein the instructions further cause the processor to perform steps comprising:
accessing an item recommendation ranking model of the online system, wherein the item recommendation ranking model is trained to generate a score for each item of a plurality of items;
applying the item recommendation ranking model to generate, based on at least one of first data associated with the one or more geographical locations, second data with further information about the travel, or third data including a portion of the user data, the score for each item of the plurality of items; and
applying the item recommendation ranking model to identify, based on the score for each item of the plurality of items, the list of one or more items for recommendation to the user.

20. A computer system comprising:
a processor; and
a non-transitory computer-readable storage medium having instructions that, when executed by the processor, cause the computer system to perform steps comprising:
responsive to a user of an online system engaging with the online system, accessing a travel prediction computer model of the online system, wherein the travel prediction computer model is trained to output a likelihood of the user conducting a travel within a future time period;
applying the travel prediction computer model to output, based at least in part on user data associated with the user, the likelihood of the user conducting the travel within the future time period;
responsive to the likelihood of the user conducting the travel being above a threshold value, generating, based at least in part on information about conversion by the user of a set of items during a past time period, a list of one or more items for recommendation to the user; and
causing a device associated with the user to display a user interface with the list of one or more items for inclusion into a cart of the user.
